(19) United States
(12) Patent Application Publication
(10) Pub. No.: US 2021/0355792 A1
(43) Pub. Date: Nov. 18, 2021

(54) RETROFIT FLUID AND GAS PERMEABLE BARRIER FOR WELLBORE USE

(71) Applicant: Aarbakke Innovation AS, Bryne (NO)

(72) Inventors: Henning Hansen, Sirevåg (NO); Robert David Eden, Glazebury (GB)

(21) Appl. No.: 17/316,681

(22) Filed: May 10, 2021

Related U.S. Application Data
(60) Provisional application No. 63/023,738, filed on May 12, 2020.

(51) Int. Cl. E21B 43/02

(52) U.S. Cl. CPC E21B 43/02; E21B 2200/08

(57) ABSTRACT

A method for making a permeable filter in a wellbore includes introducing a spacer material comprising a plurality of solid particles to a rock formation penetrated by the wellbore. A binder material is introduced to the rock formation. The binder material is susceptible to change of state from liquid to solid. The state of the binder material is changed from liquid to solid, and a size of at least some of the plurality of particles of the spacer material is reduced.

### CROSS REFERENCE TO RELATED APPLICATIONS

Priority is claimed from U.S. Provisional Application No. 63/023,738 filed on May 12, 2020 and incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of production of underground oil and gas. More specifically, the disclosure relates to a method for establishing a fluid and gas permeable barrier in a wellbore to prevent or limit sand production from the surrounding reservoir rock.

It is common that subsurface wellbores are drilled through a fluid producing reservoir rock that releases sand and other solid particles when fluids such as water, oil and gas are extracted from the reservoir rock. Sand in the produced fluids results in erosion and failures of subsurface hardware, such as valves and tubulars, as well as in surface equipment such as wellheads and flowlines. Also, sand and other particles may restrict or entirely plug off the wellbore, limiting efficient fluid transport to the surface and creating access problems for wellbore intervention tools.

A method known in the art to prevent or reduce these problems is to install a sand control system, which may be in the form of one or several filters. Such filters may minimize sand and other particles flowing into the wellbore.

However, sand control systems may fail later in the life of the well due to erosion, corrosion, etc., with the result being sand and other particles flowing into the wellbore. Also, such sand control systems may be plugged external to the wellbore by smaller than sand sized particles (“fines”) and sand, thereby greatly reducing the inflow of fluids to the well. This leads to a requirement to repair the damage or open up one or several areas otherwise sealed from the rock formations by pipe or casing. In wellbore sand control systems, there are frequently blank (unperforated) pipe sections which can be penetrated to allow fluid inflow into the wellbore.

### SUMMARY

One aspect of the present disclosure is a method for making a permeable filter in a wellbore. A method according to this aspect of the disclosure includes introducing a spacer material comprising a plurality of solid particles to a rock formation penetrated by the wellbore. A binder material is introduced to the rock formation. The binder material is susceptible to change of state from liquid to solid. The state of the binder material is changed from liquid to solid, and a size of at least some of the plurality of particles of the spacer material is reduced.

In some embodiments, the reducing size comprises shrinking the particles.

In some embodiments, the reducing size comprises partially dissolving the particles.

In some embodiments, the reducing size comprises breaking the particles.

In some embodiments, the changing state comprises heating.

In some embodiments, the binder material comprises thermoset plastic.

In some embodiments, the changing state comprises cooling.

In some embodiments, the binder material comprises at least one of a metal alloy and a thermoplastic.

In some embodiments, a fusing temperature of the binder material is chosen to be greater than a temperature of the rock formation.

In some embodiments, the changing state comprises chemically reacting.

In some embodiments, the introducing spacer material comprises placing the spacer material in a void outside a tubular disposed in the wellbore.

In some embodiments, the introducing spacer material comprises depositing the spacer material on the rock formation from a window cut in a wellbore tubular.

In some embodiments, the introducing binder material comprises moving liquid to void spaces between particles in the spacer material.

Some embodiments further comprise changing state of the binder material from solid to liquid prior to the introducing the binder material.

In some embodiments, the changing state from solid to liquid comprises heating.

Other aspects and possible advantages will be apparent from the description and claims that follow.

### BRIEF DESCRIPTION OF THE DRAWINGS

FIG. 1 illustrates a wellbore section where one or more void(s) outside the tubular have formed due to reservoir rock erosion caused by fluid flow into the wellbore.

FIG. 2 illustrates an example embodiment of a wellbore intervention tool that may be used in accordance with the present disclosure.

FIG. 3 illustrates the same wellbore section as in FIG. 1, where the intervention tool is positioned at the required location to perform a method according to this disclosure.

FIG. 4 illustrates a spacer material being injected into the void by the wellbore intervention tool.

FIG. 5 illustrates a binding material being injected between spheres or small components of the previously placed spacer material.

FIG. 6 illustrates a wellbore where a “window” has been created, e.g., milled in a wellbore tubular.

FIG. 7 illustrates a wellbore intervention tool placed within the tubular, next to the milled window from FIG. 6.

FIG. 7A shows a cross-sectional view of part of the wellbore intervention tool shown in FIG. 7.

FIG. 8 illustrates that the wellbore intervention tool has released a retrofit sand control compound into the window.

FIG. 9 illustrates the wellbore after the well intervention tool has been retrieved.

FIG. 10 illustrates how a sand control system based on injection of spacer material and binding material can be installed in a new wellbore.

FIG. 11 illustrates that the sand control compound has melted with the result of said compound having flowed out to contact the drilled wellbore.

FIG. 12 illustrates how cementing of a casing string or liner above the above described sand control system may be performed.

FIG. 13 illustrates an additional possible feature of what was described with reference to FIG. 12, which is that the lower end of the casing string may be equipped with a sealing feature that mates into the sand control system installed below the casing string or liner.

### DETAILED DESCRIPTION

The present disclosure sets forth a wellbore intervention tool-based method to install a fluid permeable material in areas external to a wellbore tubular such as casing or liner. Such fluid permeable material may form a filter to enable fluid flow into the wellbore, yet exclude movement into the wellbore of solid particles from the rock formations outside the wellbore. The methods disclosed herein can be used for repairing failures of existing sand control devices as explained in the Background section herein, but may also be as a sand control system for new wellbores. Methods disclosed herein may be performed using tools conveyed, for example, by electrical cable (wireline), semi-stiff spoolable rod, coiled tubing, slickline or other conveyance that does not require the use of a jointed tubing hoisting device (drilling rig or workover rig), although such hoisting devices may be used in connection with methods disclosed herein as may be suitable in particular circumstances.

The methods disclosed herein may comprise placing spheres, granules, chips, pellets or otherwise shaped small size components (which may be referred to herein as “particles” for convenience) of a solid material in an area of interest first, where the particles may, for example, be made from glass, plastic, rubber, metals, ceramics or minerals. Such particles may be referred to as a “spacer material” for introduction into the area of interest.

Following introduction of the spacer material into the area of interest, a binder material, e.g., a low melting point metal, curable (e.g., by chemical reaction) resin, thermoplastic or thermoset plastic, or other material that can change state from liquid to solid, can be injected or introduced into the same area into void spaces between and surrounding the particles of the spacer material. The binder material may be transported within a placement tool in the form of a liquid, with solidification subsequent to placement, or the binder material may be transported as a solid within the placement tool, for subsequent change of state to liquid, and then another state change from liquid back to solid to permanently emplace the binder material.

For binder material that operates by undergoing state change as a result of heating/cooling through its melting point temperature, it will be appreciated that the composition of the binder material may be chosen so that the melting point temperature is a convenient amount just below the expected temperature in the wellbore at the depth of the area of interest. In this way, changing the state of the binder material to liquid may be obtained with a relatively small amount of heating, and at the same time, the risk of inadvertent change to liquid state is reduced.

Some or all of the particles in the spacer material may be later reduced in size from their size at the time of placement. Such reduction in size may be obtained, for example, by partial or complete solution or by shrinking the material, depending on the material and/or the method used. Reducing spacer material particle size results in creation of fluid permeable channels through which fluid can flow from the reservoir rock into the wellbore. By such process, a sand control “filter” may be established outside the wellbore, or in some embodiments, along the wellbore wall for wellbores not having a casing or liner in the reservoir rock. The solution or shrinkage of the spacer material particles may be obtained, for example, by exposing the spacer material to a specific fluid, e.g., in the case of calcium carbonate particles, the fluid may be an acid. Some spacer materials may be caused to shrink by exposing the particles to elevated temperature. Other materials such as glass may have particles fractured, broken or shattered, and thereby reduced in size by application of shock stress. In general, the composition of the particles may be chosen to facilitate later shrinkage of the particle size by applying shock waves, heat, chemical reagents or by any other suitable means to cause such solution and/or shrinkage of the particle size.

Although this disclosure sets forth a “filter” that may be relatively short length, it should be understood that using such a method may also apply to making longer sections external to a wellbore tubular, or to a wellbore without a tubular string in the reservoir rock. The discharge of the binder material as well as the spacer material can be performed from the lower end of a wellbore intervention tool. In such wellbores, the axial center of the “filter” may be drilled out in the center after it is placed, if required.

Depending on the spacer material and the binder material used, there may be disparate densities between the binder material and the spacer material. However, such disparate densities are not expected to result in gravity-induced separation of the binder material from the spacer material. For example, a binder material with a density of around 8.5 g/cm³, e.g. bismuth-tin eutectic mixture, used with a spacer material with a density of around 2.2 g/cm³, e.g., glass beads, may be expected not to separate because of different densities, provided that the spacer material is tightly packed and each of the particles is in in intimate contact with its neighboring particles.

Using a mineral spacer material, such as calcium carbonate, with a density of around 2.8 g/cm³, would create the opportunity to remove the carbonate using, e.g., inhibited hydrochloric acid, leaving an open cell matrix. This filter type would typically be of high permeability.

In some embodiments, using a spacer material of high density polyethylene pellets with a density of around 1.0 g/cm³ and coefficient of thermal expansion around 10× that of the bismuth-tin alloy binder material, would create an open celled matrix, with each cell “filled” with a loose fitting particle, around which produced fluids may flow. This filter type would typically be of relatively low permeability.

Although the foregoing description contemplates introducing the spacer material first and then the binder material, in some embodiments, the binder material and the spacer material may be mixed prior to introduction.

In some embodiments, the spacer material and binder material may be placed in contact with a rock formation through a window in the wellbore tubular. The window may be milled in an already emplaced wellbore tubular, or may be formed in a wellbore tubular to be installed in the well. In some embodiments, the spacer material and the binder material may be placed in contact with the rock formation from within a wellbore having no tubular adjacent to the relevant rock formation. In such embodiments, the wellbore intervention tool may be used to convey a perforated tube to remain in the wellbore after solidification of the binder material to provide an open, unrestricted passage through the wellbore.

A wellbore intervention tool deployed by wireline, coiled or jointed tubes or any other known conveyance may be used to place the first batch of spacer material, as well as the binder material. In some embodiments, spacer and binder materials may be pumped into the wellbore from the surface through wellbore tubulars or through intervention tubulars such as coiled tubing or jointed tubing. In some embodiments, the spacer material and binder material may be mixed together at the surface, and discharged from the tool or intervention tubular when at a required location (depth) in the wellbore.

In some embodiments, a window may be cut or milled in a wellbore tubular, as may be performed, for example using a tool known as the Micro-Tube Removal Tool, offered by Aarbakke Innovation AS, Bryne, Norway. After the window is milled or cut, a mixture of dissolving material spheres and spacer material may be placed into the window. The spheres and the spacer material may be fused (melted) and placed into the wellbore intervention tool at the surface, where activating a heater module in the wellbore intervention tool releases the foregoing materials so that gravity may place the fused materials into the window.

The present disclosure also sets forth an additional method of placing a sand control system in a new wellbore as an alternative to known, complex sand control systems requiring gravel packing.

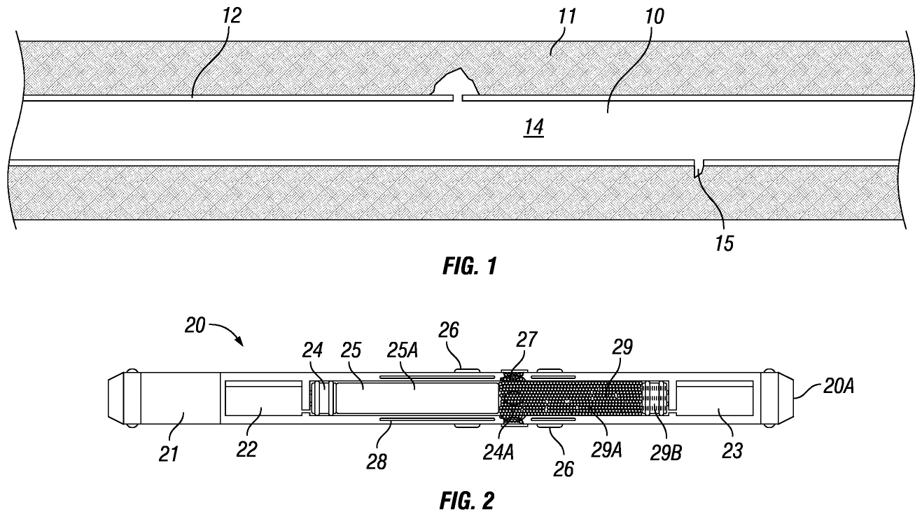

FIG. 1 illustrates a wellbore 10 drilled through a rock formation 11. The wellbore 10 may have disposed therein a string of tubular or pipe 12, such as casing or liner, a section of which is where one or several void(s) 14 outside the tubular 12 has formed due to reservoir rock erosion as a result of fluid flow into the wellbore 10. Such voids may also be created intentionally, e.g., by a well intervention tool or method such as indicated at 15, to allow a sand controlling fluid permeable barrier to be installed.

FIG. 2 illustrates an example embodiment of a wellbore intervention tool 20. In FIG. 2 the wellbore intervention tool 20 is not shown connected to a deployment device that would be used to convey the wellbore intervention tool 20 into and out of a wellbore, e.g., wireline, coiled tubing, jointed tubing or other suitable means for clarity of the illustration. In FIG. 2, the following main components or modules may be implemented in an embodiment of the wellbore intervention tool 20 may include the following.

A Control and Monitoring module 21 may contain electronics and an electrical driver system to operate a heater 28, fluid control valves, sensors, etc. (not shown separately). A first chamber 22 may contain a pressurized fluid, for example, a volume of pressurized gas used to provide the energy to discharge a fluid when required. A piston 24 may be disposed in a cylinder to displace material from a second chamber 25A, where a binder material 25 is initially disposed within. The binder material 25 may be, for example, a low melting point metal such as a eutectic mixture of bismuth and tin, lead and tin or the like; curable resins, thermoplastic or other suitable material that can be displaced in liquid form and subsequently solidify. Externally to the second chamber 25A, but within the outer body of the tool 20, there may be disposed one or more heating elements incorporated as shown generally at 28, where the heating elements 28 may be individually operated and controlled or may be operated simultaneously. The heating elements 28 can be used, for suitable materials, to melt the binding material 25 to enable it to be discharged from the second chamber 25A, as well as to heat the wellbore section adjacent to the tool 20. Such wellbore heating may be used to activate or cure the binder material as discharged into the rock formation (11 in FIG. 1). Also, the heating elements may be used to shrink or assist in the dissolving of spacer material 29 placed externally, as well as to release the tool 20 from any binder material 25 located between the tool 20 and the wellbore tubular or the wellbore when no tubular is emplaced.

Two longitudinally spaced apart annular sealing elements 26 may be placed on the exterior of the tool 20 above and below discharge ports 27, from which the binder material 25 and a spacer material 29 may be discharged from the tool 20. These sealing elements 26 are provided to ensure that fluids and materials discharged from the tool 20 will go only into the area of interest outside the tool 20 and the wellbore tubular (e.g., 12 in FIG. 1 if the wellbore is so configured). The sealing elements 26 can also be used to enable pressurizing a void externally of the wellbore tubular (12 in FIG. 1), to verify that the tool 20 is located at the required position, among other uses. The sealing elements 26 may be inflatable elastomer seals that can be inflated to provide the required sealing and deflated to enable the tool 20 to freely traverse the wellbore.

The discharge ports 27, and in some embodiments an outer flexible sleeve (not shown) may open, e.g., by opening a solenoid operated valve (not shown) to discharge the respective material, e.g., binder material 25 and/or spacer material 29, as soon as pressure is activated from within the tool 20. Such activation may take place by applying pressure from the first chamber 22 to the first piston 24 to displace the binder material 25, and/or by applying pressure from a fourth chamber 23 such as gas pressure, to displace a second piston 29A in a third chamber 29A having the spacer material 29 initially disposed therein. Such a sleeve may also ease the release from any binder material located outside the tool 20 after a completed operation.

The third chamber 29A with spacer material 29 therein, may also have heating elements (not shown in FIG. 2) placed externally as the heating elements 28 outside the second chamber 25A. The spacer material 29 can be of a type as explained above.

A lower guided end 20A may be provided to facilitate moving the tool 20 through a wellbore, particularly highly inclined or horizontal wellbores

The tool 20 can be operated (e.g., by using the heaters 28) to pre-heat the tubular(s) and the near wellbore area (i.e., in the rock formation) external to the wellbore tubular where the tool 20 is deployed. Such pre-heating may improve injection of the binder and spacer materials, that is, to reduce the possibility of a fusible material becoming solid on contact with the wellbore tubular and/or the rock formation.

Support and/or centralizing wheels or the line (not shown) may be provided to the tool 20 to assist in centralizing and transporting the tool 20 in the wellbore. In some embodiments, rather than using pressurized chambers, e.g., 22 and 23 exist, the respective materials 25 and 29 may be disposed using, for example, a motor operated screw mechanism coupled to the respective piston 24, 29B to displace it. Those skilled in the art of wellbore intervention tools will appreciate that other possible implementations may be used to controllably displace the binder material 25 and the spacer material 29 from the tool 20, and the disclosed embodiments are not intended to limit the scope of the present disclosure.

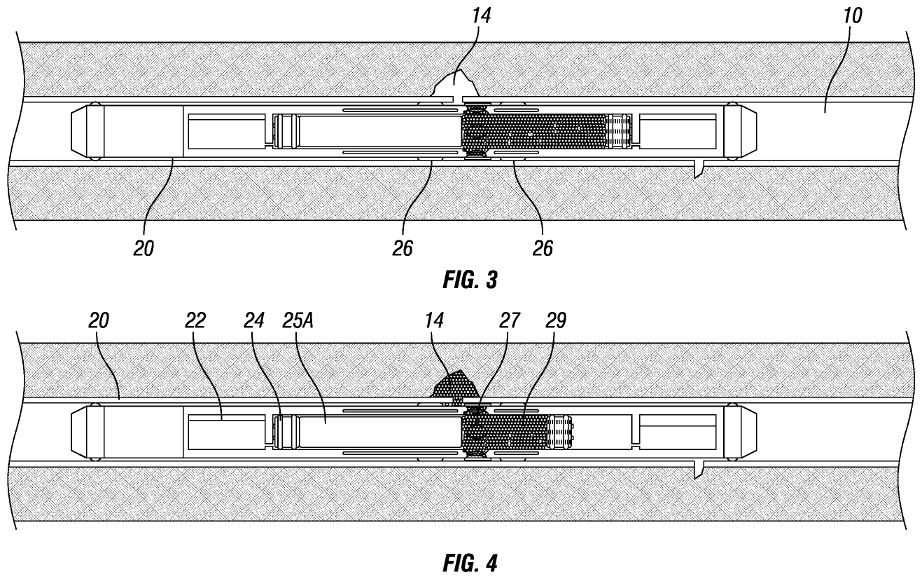

FIG. 3 illustrates the same wellbore section shown in FIG. 1, where the wellbore intervention tool 20 is positioned at the required wellbore location. The required location in the present example is such that the sealing elements 26 are disposed on either longitudinal side of the void 14. Verifying the correct location in the wellbore can be performed by several techniques known in the art, for example using a casing collar locator (CCL), using a camera attached to the tool 20, by disposing a plug or similar pre-installed wellbore device that the lower end of the tool 20 can land on, by using an acoustic scanning tool as for example a scanning module that is contained in the Micro-Tube Remover Tool set forth above, among other possible devices to locate the tool in the intended location. When the correct location has been found, the sealing elements 26 may be activated. Applying pressure between these two sealing element can be used as an added verification of correct tool location.

FIG. 4 illustrates the spacer material 29 being injected into the void 14 from the intervention tool 20. Injection may be performed by opening a release valve mechanism (not shown) located between the fourth chamber 23 and the second piston 29B. Pressure on the second piston 29B displaces it into the third chamber 29A, thus displacing the spacer material 29 out of the tool 20 through the discharge ports 27. One or several fluid flow-through ports and nozzles can be implemented in the second piston 29B to assist in the discharge of the spacer material 29. When the void 14 has received a predetermined amount of spacer material 29, or the second piston 29B reaches the end of its travel, the pressure observed in the fourth chamber 23 will become stable, informing the tool operator that such an event has taken place.

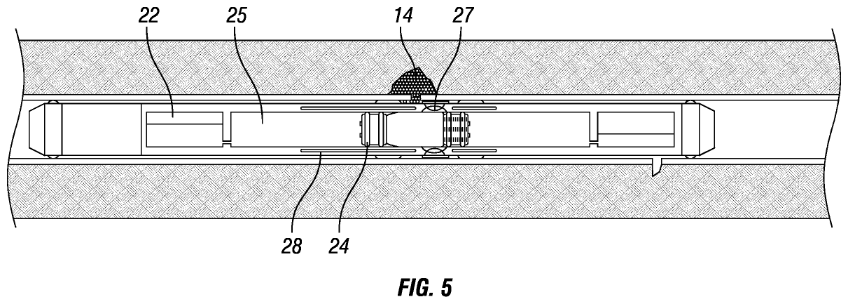

FIG. 5 illustrates the binding material 25 being injected into the void 14, wherein the previously placed particles of the spacer material (29 in FIG. 4) are already disposed. The binding material 25 may be injected by applying pressure from the first chamber 2 to the first piston 24, thus displacing the binder material 25 from the second chamber 25A, out though the discharge ports 27 and into the void 14.

For example, by activating the heating elements 28, fused material within the second chamber 25A will flow into the void 14. The operation and discharge of the binding material 25 may thus be similar to the sequence described with reference to FIG. 4 for the spacer material (29 in FIG. 4). When displacing the binder material 25 is completed, and the binding material has been cured or otherwise solidified, the tool 20 may be released, e.g., by deflating the annular sealing elements (26 in FIG. 2) and then retrieved to the surface.

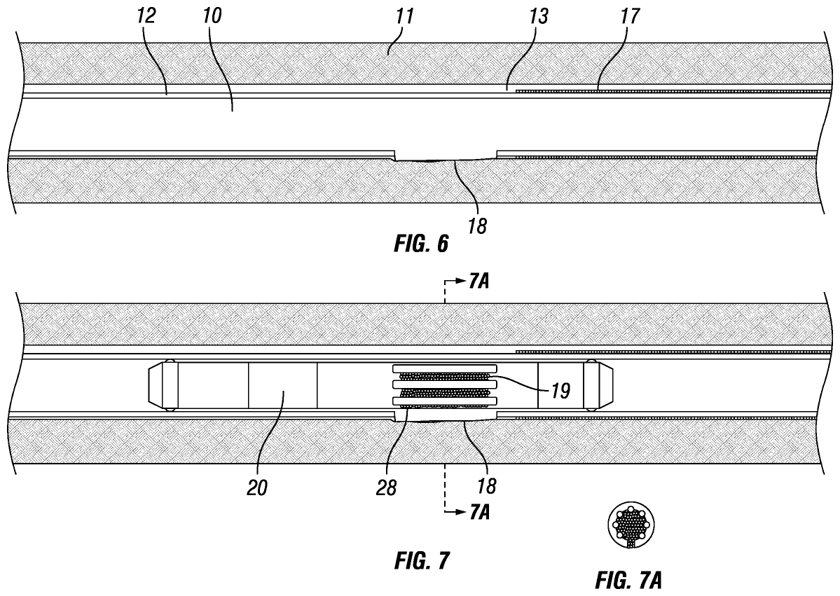

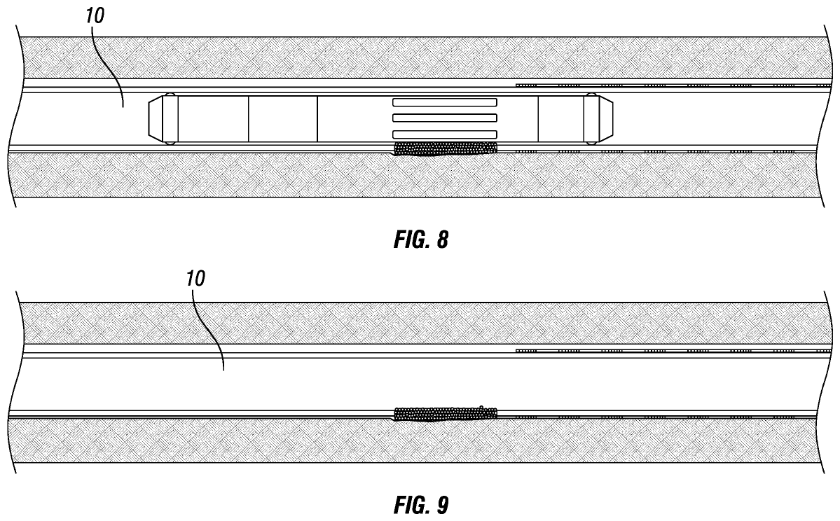

FIG. 6 illustrates a wellbore 10 having a sand screen 17 disposed along a wellbore tubular 12, which tubular 12 may be held in place in the wellbore 10 by cement 13. A so-called “window” 18 has been created in a wellbore tubular 12 at a position longitudinally displaced from the sand screen 17. FIG. 7 illustrates a wellbore intervention tool 20 placed within the wellbore tubular 20 as in FIG. 6, disposed longitudinally alongside the previously created window 18. The wellbore intervention tool 20 may comprise a plurality of heating elements 28 arranged circumferentially around a body of fusible material 19. The fusible material 19, upon heating by the heating elements 28, liquefies and then flows by gravity into the window 18. After the fusible material 19 is disposed in the window 18, the heating elements 28 may be switched off, and the tool 20 may be withdrawn from the wellbore 10. FIG. 8 illustrates the wellbore 10 after the wellbore intervention tool 20 has released the fusible material 19, e.g., a retrofit sand control compound, into the window (18 in FIG. 7). FIG. 9 illustrates the wellbore 10 after the wellbore intervention tool (20 in FIG. 7) has been retrieved from the wellbore 10. FIG. 7A shows a cross-sectional view of part of the wellbore intervention tool shown in FIG. 7.

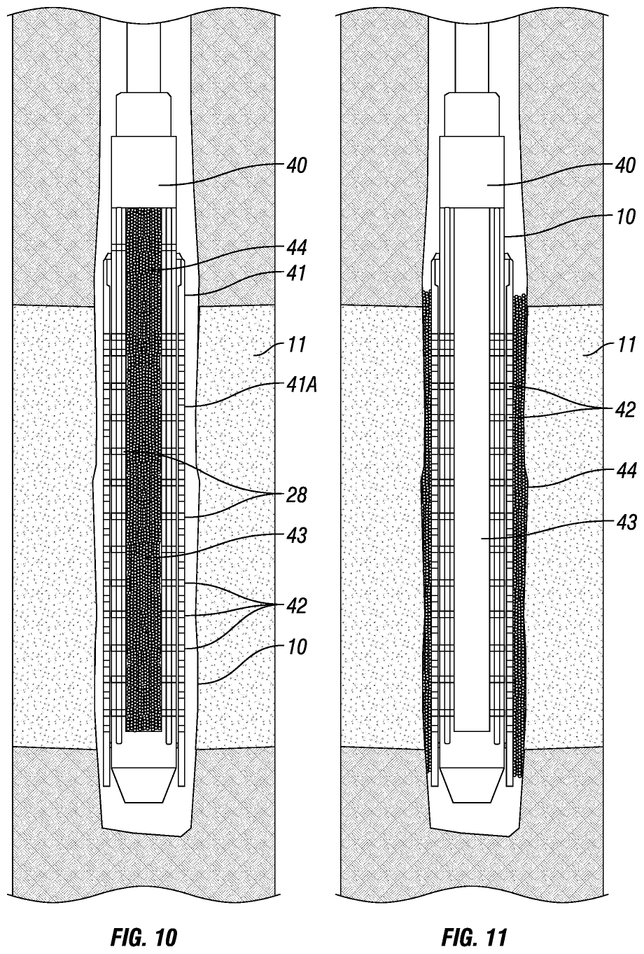

FIG. 10 illustrates how a sand control system, based on methods as described above, can be installed in a new wellbore, in some embodiments in a wellbore that does not include a casing or liner. In FIG. 10, for example, a sand control system may be installed as an alternative to sand control systems based on gravel packing. A placement tool 40 may be deployed to a required depth in a wellbore 10, as shown in FIG. 10 in a reservoir rock formation 11. The placement tool 40 may comprise one or more heating elements 28 disposed in or on a tool housing 41. The tool housing 41 may comprise a plurality of ports 42 extending between the exterior surface 41A of the tool housing 41 and an internal chamber 43 disposed inside the tool housing 41. The chamber 43 may be initially filled with a sand control mixture 44 that is susceptible to change from solid to liquid, for example, by heating, and back again to solid after discharge and cooling. The fusing temperature of the sand control mixture 44 may be chosen based on the expected temperature in the wellbore 10 at the position of the rock formation 11, such that a relatively small increase in temperature is all that would be required to change the state of the sand control mixture 44 to liquid. The heating of the sand control mixture 44 by operating the heating element(s) 28 will also heat the near wellbore area of the rock formation 11, causing a better flow-in and anchoring of the sand control mixture 44. Continuous heating until the sand control mixture 44 has been placed in the wellbore 10 may help ensure that the sand control mixture 44 flows into to all open voids in the rock formation 11. The sand control mixture 44 is illustrated in FIG. 10 as being located in the chamber 43 within the tool housing 41, but it should also be understood that the sand control mixture 44 can be located externally, on the tool housing 41, as well as both externally on the tool housing 41 and internally as in the chamber 43.

FIG. 11 illustrates that the sand control mixture 44 has fused, with the result that the sand control mixture 44 has flowed out from the chamber 43 to contact the drilled wellbore 10 by passing through the ports 42 in the tool housing. Although not shown in FIGS. 10 and 11, it will be appreciated by those skilled in the art that that the placement tool 40 may include one or more annular sealing elements, such as shown at 26 in FIG. 2, to constrain movement of the sand control mixture 44 to within a predetermined axial span within the wellbore 10. The embodiment shown in FIGS. 10 and 11 contemplates that the sand control mixture 44 moves from within the placement tool 40 to the wellbore 10 by gravity; it should be clearly understood that the sand control mixture 44 can be displaced from within the placement tool 40 by pressure, such as explained with reference to FIGS. 4 and 5. Furthermore, the ported tool housing 41 shown in FIGS. 10 and 11 in some embodiments may be separable from the placement tool 40 such as by shear pins, remotely operable latches or any other known release mechanism such that the ported tool housing 41 remains in the wellbore 10 when the placement tool 40 is retrieved from the wellbore 10.

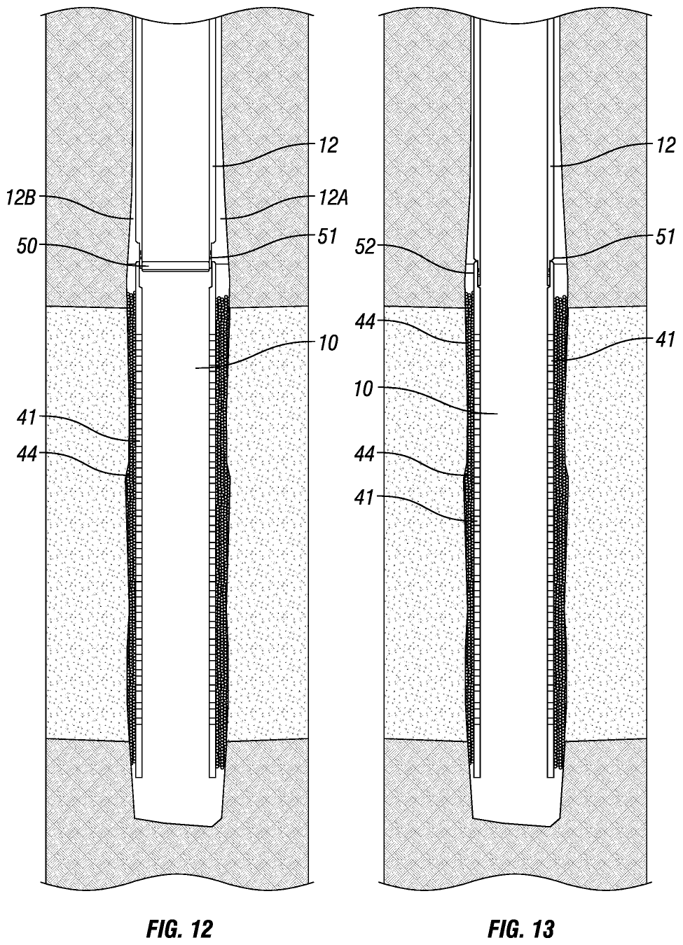

FIG. 12 illustrates cementing of a casing string 12 in a wellbore 10 above a sand control system emplaced as described above with reference to FIGS. 10 and 11. A temporary barrier 50, for example, a glass plug or metal rupture disk or burst disk may be placed at the bottom of the casing string (or liner string, which may be used with equal effect as it related to the present embodiment). The temporary barrier 50 fluidly isolates between the sand control system below the temporary barrier 50 and the casing 12 above. Above the temporary barrier 50, cement may be circulated through an annular space 12B between the wellbore 10 and the casing string 12 through discharge port(s) 51 located above the temporary barrier 50, wherein cement may be pumped into the casing 12 and out to the annulus 12B via said port(s) 51. The temporary barrier 50 may be removed such as by breaking with a tool in the case of a glass disk, or by pressurizing the wellbore 10 above burst pressure when a burst disk is used. Other temporary barriers such as retrievable bridge plugs are known in the art and may be used in some embodiments.

FIG. 13 illustrates and additional possible feature that may be used in connection with the embodiment described with reference to FIG. 12, which is that the lower end of the casing string 12 is equipped with a sealing feature 52 located below the discharge port(s) 51 and that the sand control system is equipped with a fitted sealing area that the seal feature 52 can be landed into after completed cement placement.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A method for making a permeable filter in a wellbore, comprising:
introducing a spacer material comprising a plurality of solid particles to a rock formation penetrated by the wellbore;
introducing a binder material to the rock formation, the binder material susceptible to change of state from liquid to solid;
changing the state of the binder material from liquid to solid; and
reducing a size of at least some of the plurality of particles of the spacer material.

2. The method of claim 1 wherein the reducing size comprises shrinking the particles.

3. The method of claim 1 wherein the reducing size comprises partially dissolving the particles.

4. The method of claim 1 wherein the reducing size comprises breaking the particles.

5. The method of claim 1 wherein the changing state comprises heating.

6. The method of claim 5 wherein the binder material comprises thermoset plastic.

7. The method of claim 1 wherein the changing state comprises cooling.

8. The method of claim 7 wherein the binder material comprises at least one of a metal alloy and a thermoplastic.

9. The method of claim 7 wherein a fusing temperature of the binder material is chosen to be greater than a temperature of the rock formation.

10. The method of claim 1 wherein the changing state comprises chemically reacting.

11. The method of claim 1 wherein the introducing spacer material comprises placing the spacer material in a void outside a tubular disposed in the wellbore.

12. The method of claim 1 wherein the introducing spacer material comprises depositing the spacer material on the rock formation from a window cut in a wellbore tubular.

13. The method of claim 1 wherein the introducing binder material comprises moving liquid to void spaces between particles in the spacer material.

14. The method of claim 1 further comprising changing state of the binder material from solid to liquid prior to the introducing the binder material.

15. The method of claim 14 wherein the changing state from solid to liquid comprises heating.
